(19) United States
(12) Patent Application Publication
(10) Pub. No.: US 2009/0125397 A1
(43) Pub. Date: May 14, 2009

(54) METHOD AND SYSTEM FOR INTEGRATING RANKINGS OF JOURNALED INTERNET CONTENT AND CONSUMER MEDIA PREFERENCES FOR USE IN MARKETING PROFILES

(75) Inventors: Ahmed A. Gomaa, Glen Ridge, NJ (US); Sotirios G. Ziavras, Fort Lee, NJ (US); Muhammad Zafrul Hasan, College Station, TX (US)

Correspondence Address: DARBY & DARBY P.C., P.O. BOX 770, Church Street Station, New York, NY, 10008-0770, US

(73) Assignee: iMedia Streams, LLC, Newark, NJ (US)

(21) Appl. No.: 12/247,739

(22) Filed: Oct. 8, 2008

Related U.S. Application Data
(60) Provisional application No. 60/978,241, filed on Oct. 8, 2007.

(51) Int. Cl. G06Q 30/00; G06Q 90/00; H04N 7/173

(52) U.S. Cl. 705/14; 705/1; 725/132

(57) ABSTRACT

A method and system for integrating data-source consumer-preference data and internet-medium consumer-preference data for use in targeted advertising and ranking content. Consumer-preference data is determined based on user-interactions with a data source, such as a set-top-box. The data source is classified based on a monitoring taxonomy that specifies content categories and relationships between the categories. The consumer-preference data and the data source classification are aggregated with other preference and classification data, which is used to rank the data source classification data. Journaled internet data sources are analyzed using the monitoring taxonomy to determine internet-medium consumer-preference data. The journaled internet data sources are ranked based interest level, direction level, or authority level. A content category ranking is computed using the ranking of data source classifications and the ranking of the journaled internet data sources, which can be provided as an advertising data input or a standalone content ranking reporting tool.

This application claims priority pursuant to 35 U.S.C. § 119(e) to U.S. Provisional Patent Application Ser. No. 60/978,241 entitled “Bridging the Communication Divide by Connecting Online and Offline User Behavior for Targeted Online Marketing” and filed on Oct. 8, 2007, which is hereby incorporated by reference as though set forth herein its entirety.

### FIELD OF INVENTION

The present invention relates to the determination of consumer preferences for use in marketing and advertising and more particularly to the ranking and categorization of preferences in internet-media and entertainment-media and the correlation thereof for use in advertising.

### BACKGROUND OF THE INVENTION

Marketers and advertisers are often concerned with determining the best placement for an advertisement within a media stream and inserting the advertisement accordingly for greatest exposure, impact and influence. The best placement typically corresponds to inserting an advertisement in a particular media stream most likely to be viewed by the largest audience possible that is interested in the subject or content of the advertisements.

Much research is conducted investigating audience preferences and interests to ensure the best placement of advertisements. Companies such as Nielsen BuzzMetrics attempt to gauge the audience size of television shows. Other companies use data mining to find correlations between various products and service purchases. For example, if a consumer purchases product A, data mining is used to test whether that consumer is more or less likely to purchase product B. Advertisers also examine the content of the medium (e.g., subject of a television show or radio program) to identify products or services that are related to the content of the medium, or that have been found to be of interest to the audience of the content. For example, brokerage firms may purchase advertising time during a television show concerning stock market news. Advertisers are continually searching for new data to examine and mine to determine correlative interests of consumers of various media content.

One source of data for advertisement profiling is the communities that form and gather on the Internet. These communities typically form around a common interest, such as a television show, support of a politician, or use of a particular consumer product. Community opinions are expressed by postings to message boards and web logs (i.e., “blogs”).

Message boards and blogs can be considered journaled internet data due to the way in which they are updated by the community. Message boards allow anyone in the community to start a new conversation topic, post a message to a conversation topic, or respond to another post. A blog is generally operated and maintained by a single person or small group of people, posting information to be added to the blog. The readers of the blog can also comment on the post through an interface similar to a message board. Frequently, blog posts reference other blog posts. The popularity or influence of a blog is often judged based on the number of other blogs or internet postings that reference (e.g., hyperlink) to the blog. Additionally, the quantity and tone of the follow-up comments to the blog provide another indication of the popularity and response to a blog posting.

Unfortunately, the egalitarian nature of the internet makes it difficult to discern reliable and tested information from journaled internet data. A blog that is only read by a handful of people superficially appears to have the same importance to an advertiser as a blog having thousands of readers. Conversely, if a blog has many readers, the subject matter of that blog may not be more important than a blog having only a handful of readers, if the subject matter of the less widely read blog is also discussed on many other blogs.

Currently, the insight provided by these various sources of consumer preference data are discrete data points that are viewed in isolation. The analysis of these data sources is not combined to verify and enhance the conclusions derived from each individual source.

What is needed is a way to analyze the content of journaled internet data sources and measure the reliability and importance of the data source. Further, a system for integrating the various distinct sources of data regarding consumer preference is needed to verify and increase the reliability and usefulness of the analysis of the data sources.

### SUMMARY OF THE INVENTION

In accordance with one aspect of the present invention, a method of integrating entertainment-media preference data and internet-media consumer preference data for use in targeted advertising is provided. A first consumer preference is determined based on a user-interaction with an entertainment-media, and the entertainment-media is classified in accordance with a monitoring taxonomy that specifies content categories and relationships between the content categories. The consumer preference data and the entertainment-media classification are aggregated with other similar data. The entertainment-medium classifications are then ranked based on the consumer preference data. Journaled internet data sources are also analyzed using the monitoring taxonomy to determine internet-medium consumer preference data, which is then ranked, based on an interest level, a direction level, or an authority level. Using the rankings of the entertainment-medium classifications and the rankings of the journaled internet data sources a content category ranking can be computed and provided as an advertising data input.

### BRIEF DESCRIPTION OF THE FIGURES

The foregoing and other features of the present invention will be more readily apparent from the following detailed description and drawings of illustrative embodiments of the invention in which:

FIG. 1 is a flow diagram of a process for and categorizing journaled internet data sources and determining content category rankings in accordance with the present invention; and

FIG. 2 is a flow diagram of a process for integrating entertainment-medium consumer preference data and internet-medium consumer preference data for use in targeted advertising.

### DETAILED DESCRIPTION OF PREFERRED EMBODIMENTS

By way of overview and introduction, the present invention enables advertisers to gather data from journaled internet data sources, such as blogs and message boards, concerning the content of the data sources (e.g., the community interest in the content, the increase or decrease in the interest, and the authority of the data source). That is, for example, a number of blogs can be analyzed to determine their content-category (e.g., by use of keywords). A content-category that is more frequently discussed relative to other content categories would be considered to have a higher interest level. Additionally, the interest level of a content category can be monitored over time to determine direction level, i.e., whether the content-category is generating increasing or decreasing interest. The journaled internet data sources can also be ranked based on the interest level, direction level, and authority level as described in U.S. Provisional Patent Application Ser. No. 61/080,022, which is hereby incorporated by reference as though set forth in its entirety. Thus, interest and trends in content-categories and blogs can also be correlated to one another for cross-marketing products. The rankings and correlations can then be used for better targeting of advertisements.

In a further aspect of the present invention, data concerning consumer consumption of entertainment-media (e.g., television, movies, and radio) can be gathered based on user interactions with those media and processed in combination with the rankings of the journaled internet data sources to determine content category rankings for use in targeted advertising. For example, any electronic user interaction device such as set top box can be modified to record and report a user's interactions (e.g., channel changing, viewing time, and playback controls such as pause, rewind, fast-forward, etc.) These interactions can be analyzed in combination with a classification of the program being viewed to further enhance content rankings. Combining the content ranking of media consumption and the rankings of journaled internet data, more comprehensive and accurate data can be provided for use in targeting advertisements.

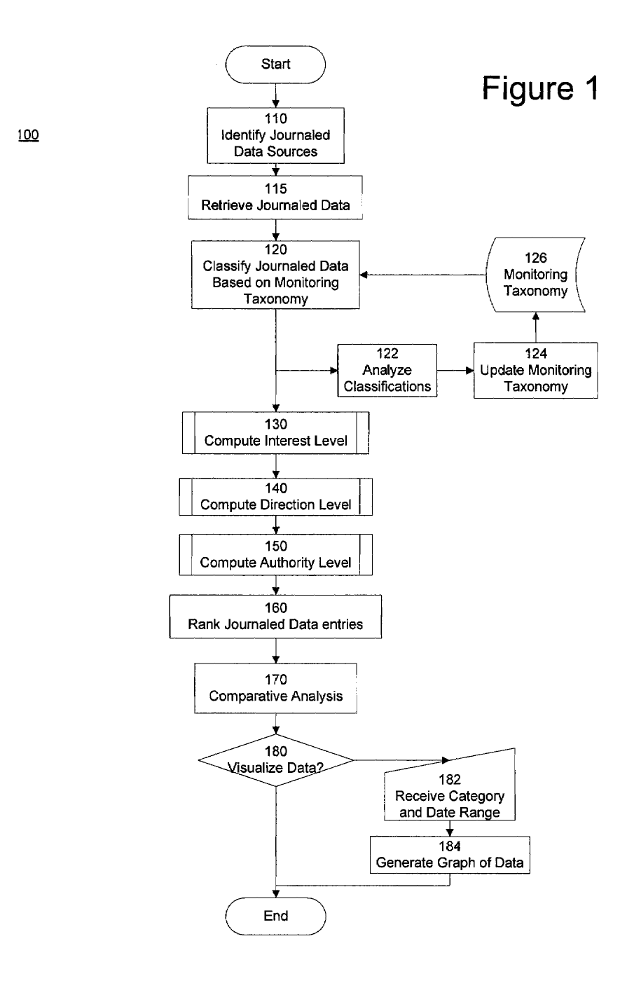

With reference to the figures, FIG. 1 is a flow diagram of a process 100 for categorizing journaled internet data sources and determining content category rankings in accordance with an embodiment the present invention. Process 100 is described below with reference to journaled internet data sources such as blogs and message boards. However, it should be understood by one of ordinary skill in the art, that the process 100 can be applied to other journaled internet data sources.

At step 110, journaled internet data sources are identified. A web crawler can be used to identify the data sources. A web crawler examines web pages and can identify hyperlinks, which can be potential data sources, and content on the web page, which can be journaled data entries. Content can be retrieved and stored, and hyperlinks (i.e., potential data sources) can be queued for later examination. Multiple web crawlers can be used concurrently on multiple computers or a single computer to increase the rate at which web sites are examined. Optionally, a specialized crawler, such as an ATOM/RSS Feed crawler for blogs, can be used to identify and examine data sources and content.

The crawler can be used to retrieve journaled data at step 115. Alternatively, Uniform Resource Locators (“URLs”) (e.g., hyperlinks) associated with journaled data entries can be stored and retrieved later by another software process, such as an archival tool or managed File Transfer Protocol (“FTP”) software (e.g., mget). The journaled data can be stored for later processing or analyzed as it is retrieved.

At step 120, the content of the retrieved journaled data is analyzed and classified. The classification can be accomplished using a natural keyword analysis to determine the content and tone (e.g., positive or negative) of the data. Additionally, metadata can be used for classification. If the journaled data includes multimedia, such as audio, video, or images, metadata embedded in the files (e.g., tags) can be examined for keywords and classifiable data.

The classification associates the journaled internet data (e.g., blog entry) with one or more content-categories that are specified in a monitoring taxonomy. The journaled internet data source (i.e., blog) can then be classified based on the classifications of the journaled data entries. The monitoring taxonomy also identifies relationships between content-content categories. For example, two or more content categories may be highly related such that a data entry classified in one category is likely to be classified in second category as well. The taxonomy can also indicate the strength of the relationship (e.g., how frequently the relationship occurs and how many times the relationship has been encountered.

The classification process can provide feedback for enhancing the monitoring taxonomy. At step 122, the classification of a particular journaled data entry can be analyzed to determine the clusters or relationships evidenced in the particular data entry. This information can be used at step 124 to enhance the monitoring taxonomy 126. New relationships can be identified and reflected in the taxonomy 126, and existing relationships can be strengthened. Relationships that have become stale (i.e., have not been encountered over a period of time) can be removed or updated to indicate a weakening of the relationship. Optionally, the journaled data entry can be re-classified at step 120 based on the updated monitoring taxonomy 126.

Using the classification of the journaled data entry and the monitoring taxonomy, a number of metrics concerning the journaled data entry can be computed. For example, an interest level can be determined at step 130. The interest level can include a measure of popularity and a density of the content. The popularity is based on the number of data entries having one or more common classifications and the number of data entries scanned. That is, the popularity measure can include the percentage of data entries having a similar classification. The density of a data entry is based on the confidence of the classification for that data entry (e.g., number of citations of a keyword mentions relative to the number of data sources that mention the keyword).

A direction level can also be computed for each journaled data entry at step 140. The direction level includes an indication of the trend in the interest of a particular data entry relative to a period of time. In one example of computing the direction level a BM25 function is used to sort the retrieved data as either positive or negative based on a predetermined set of keywords. BM25 (sometimes referred to as Okapi BM25) is a ranking function commonly used by search engines to rank matching documents according to their relevance to a given search query based on a probabilistic retrieval framework. Variants of the BM25 algorithm (e.g. BM25F, a version of BM25 that analyzes document structure and anchor text) can also be used to sort the retrieved data.

Additionally, a Naïve Keyword algorithm can be used to count the number of positive or negative keywords that are related to a certain category as specified in the taxonomy and are within a relevant position of each sentence of the journaled data entry. A weighted keyword algorithm gives different weights to each keyword and can also be used to determine the direction level, wherein each keyword is weighted based on the meaning of the word. For example “good” is weighted less than “excellent.” In a further feature, the direction level can be computed in several different ways, and a voting algorithm that combines the results of the BM25, the Naïve Keyword and the weighted keyword algorithms can be used to select the direction level.

A further metric concerning the authority of the journaled data entry can be computed at step 150. The authority of the data entry includes a computation of the Eigen Values for the number of relevant links to a particular data entry, the number of links from the data entry, the importance of the data entry (i.e., interest in the data entry) within a specific community, or the user's interactions within the content. User interactions can be captured by monitoring the number of views (e.g., accesses or requests) of a specific content and/or the number of comments made regarding a specific data entry. For example, an interaction matrix can be devised having elements that indicate the number of times a user has accessed a data entry. These interactions can be included as a vector that is utilized in computing the Eigen values. For example, the vector can be included in an Eigen-Rumer algorithm that can be used to compute the Eigen Values.

Each journaled data entry can be ranked at step 160 based on any of the computed metrics or a weighted score of a combination of metrics. The weights used for ranking can be altered to model various user profiles. For example, a particular user profile may highly value the direction (i.e., trend) level of content, but not overall interest in the content. This particular user profile would weigh the direction level more heavily than the interest level. The computed metrics can also be aggregated and sorted based on an industry category identified in the monitoring taxonomy. Thus, at step 170 a comparative analysis of the data entries can be analyzed to determine trends or anomalies within an industry.

The ranking and metrics computed in the foregoing process 100 are preferably stored in a computer readable medium. The information can be integrated into a business intelligence report as well as profiles for targeting advertisements. For example, once a particular category is associated with blogs entries, the profile of the blog authors can be considered the representative panel of the particular category. That is, if 80% of the internet bloggers writing about baby-related content are females, then 80% of the ads disseminated to blogs in the baby content category can be targeted to females. As the representative panel distribution varies each day, the ads distribution varies accordingly.

The computed data can also be visualized in various ways. If a user desires to receive a graphical representation of the data at step 180, at step 182, the user can specify a category or content-type and optionally a date range of interest. At step 184, a line chart or a bar chart is generated in illustrating the specified content-type rankings over the specified period of time.

The analysis of journaled internet data sources and data entries, as described above, provides meaningful and systematic metrics that can be considered in business analysis and marketing efforts. This data can be further enhanced by combining it with other known metrics of consumer preferences, for example, by combining the information derived from journaled internet data sources with consumer entertainment consumption habits (e.g., television viewing habits).

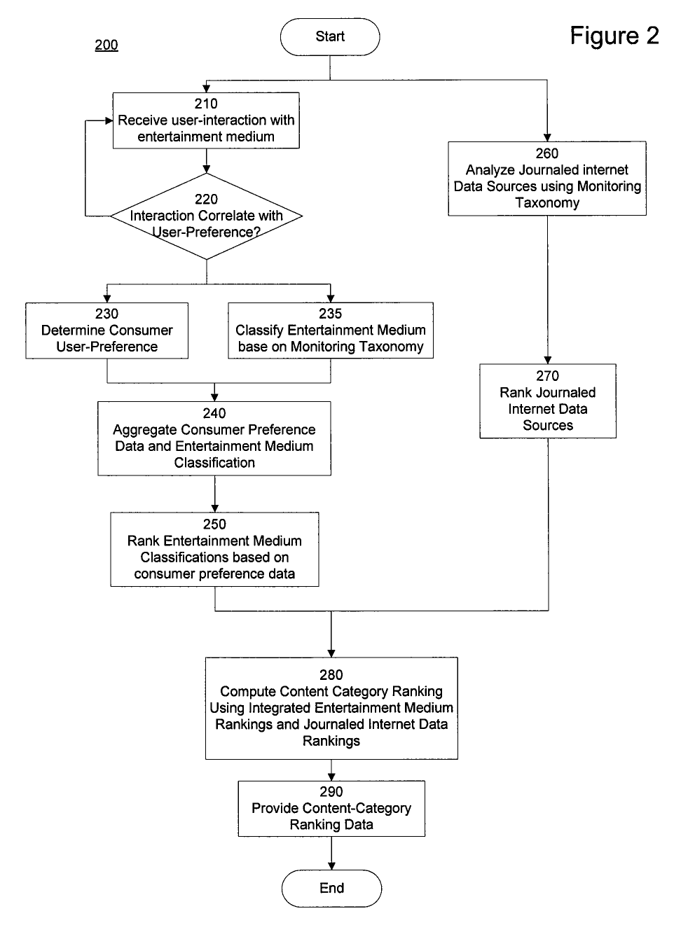

FIG. 2 is a flow diagram of a process 200 for integrating entertainment-media consumer preference data and internet-media consumer preference data for use in targeted advertising. While the process 200 is described below with reference to watching television and controlling the television using a set-top-box, it would be understood by one of ordinary skill in the art that the process 200 can be applied to other forms of data sources or communication having an interface that can be monitored such as listening to the radio or music. Furthermore, the type of data to be collected from the set top box regarding user preferences can be dynamically modified by the system server. That is, the system server can configure the set top box to collect different or additional data. Additionally, data collection can be initiated by the server through the set-top-box. For example, a message from the set top box can be displayed to the user requesting the insertion of data at predetermined or random intervals.

At step 210, a user-interaction with an entertainment-media is received. For example, a user may change the television channel by pressing the appropriate remote control button, or the user can express his opinion about the relevancy of the content to a certain age group or gender in response to a prompt from the set top box. This command is received by the set-top-box and can be recorded. In a further example, pausing, recording, playing, reviewing, or fast-forwarding a television program through digital video recorder (“DVR”) can be a monitored user-interaction.

A standard set-top-box can be modified via add-on hardware or software application to monitor user-interactions and transmit data concerning those interactions to a server for further processing. Alternatively, proprietary set-top-boxes can be utilized. The particular user-interactions monitored can be configured remotely by the server. As user-interactions are received, relevant data concerning the interaction can be transmitted to the server. Optionally, the relevant data can be aggregated and transmitted in larger data segments so as to reduce the frequency of network connections. The data can be sent periodically or after a predetermined quantity of data (e.g., number of user-interactions or data size) has been aggregated. In a further alternative, the server can periodically connect to the set-top-box and request transmission of any aggregated data.

At step 220, the received user-interaction is examined to determine if it correlates to a user-preference. If there is no correlation, the process 200 proceeds to step 210 to await further user-interactions. If, however, the user-inaction correlates to a user-preference, the particular user preference is determined at step 230. For example, changing the channel to a particular television program indicates an interest in the program. Additionally, the amount of time a viewer watches a program can be monitored as well. If a user fast-forwards through a show segment, the user's disinterest can be recorded. Alternatively, in response to a prompt from the set top box, the system can record a user-expressed opinion about the relevancy of the content with respect to the user's age and gender.

When a user-interaction correlates to a user-preference, the content of the television is classified based on the monitoring taxonomy, which optionally includes user preferences, at step 235. The monitoring taxonomy preferably specifies the genre of the program (e.g., whether the program is comedy or drama). The user-interaction aids in determining user-interest, appropriate age, or gender. TV programs can also be classified based on the relevance to a particular group such as age or gender. Classification can be performed by determining the name of the television program as identified in a schedule. Alternatively, identification information embedded in the television signal can be recorded and translated to a program name. Once the program is identified, the content can be classified by examining a program synopsis. Furthermore, the program can be classified on a per episode basis, by overall theme of the program, or based on the user interaction with the program. The details concerning the user-interaction that were received at step 210 are aggregated at step 240 with other consumer preference data and entertainment-medium classifications. The various television programs are then ranked at step 250 based on the received consumer preferences. For example, a television program having a longer average viewing time can receive a higher ranking than shorter viewing times. A further ranking example assigns a higher rank to television programs viewed at a particular time of day (e.g., prime time).

Concurrently, at step 260 and 270, journaled internet data sources are examined and ranked, for example using the process described above with respect to FIG. 1. While this step is illustrated in FIG. 2 as occurring in parallel, one of ordinary skill in the art would understand that this process can occur in serial or in parallel. Additionally, as discussed above with respect to FIG. 1, the analysis can be performed by multiple systems in a distributed network each storing information preferably in a commonly accessible database.

At step 280, a ranking of content-categories is computed by combining the ranks of the internet journaled data sources and the entertainment-medium user-preferences. If a common taxonomy, such as the monitoring taxonomy, is used to classify both the entertainment-medium and the journaled data sources, commonly classified data points can be matched and assigned an overall ranking. The overall ranking can be weighted to favor internet data over entertainment-media, or vice-versa.

The result of the combined content-category ranking can then be provided to advertisers at step 290 for targeting advertisements.

While the invention has been described in connection with certain embodiments thereof, the invention is not limited to the described embodiments but it will be understood by those of ordinary skill in the art that that various changes in form and details may be made therein without departing from the spirit and scope of the invention.

We claim:

1. A method of integrating consumer preference data and internet-medium consumer preference data for use in targeted advertising comprising:
a. determining a first consumer preference data based on a user-interaction with a data source;
b. classifying the data source based on a monitoring taxonomy, the monitoring taxonomy specifying a plurality of content categories and a plurality of relationships between the plurality of content categories;
c. aggregating the first consumer preference data and the data source classification with a plurality of consumer preference data and data source classifications;
d. ranking the plurality of data source classifications based on the plurality of consumer preference data;
e. analyzing a plurality of journaled internet data sources using the monitoring taxonomy to determine internet-medium consumer preference data;
f. ranking the journaled internet data sources based on at least one of an interest level, a direction level, and an authority level; and
g. computing a content category ranking using the ranking of the plurality of data source classifications and the ranking of the journaled internet data sources.

2. The method of claim 1 further comprising the step of transmitting the first consumer preference data to a server for further processing.

3. The method of claim 2, wherein the consumer preference data is transmitted to the server at a configurable time interval.

4. The method of claim 2 wherein the consumer preference data is transmitted to the server in response to a request from the server.

5. The method of claim 1 wherein the user-interaction with the data source includes a user-interaction with a set-top-box.

6. The method of claim 5, further comprising the step of remotely configuring the set-top-box to monitor one or more particular user-interactions.

7. The method of claim 1, wherein the consumer preference data includes a viewing time.

8. The method of claim 1, wherein the consumer preference data includes a timestamp.

9. The method of claim 8, wherein the consumer preference data includes a direct user input for viewed content at any time

10. The method of claim 1, further comprising the step of providing the content category ranking as an advertising data input.

11. A system for integrating consumer preference data and internet-medium consumer preference data for use in targeted advertising comprising server computer having a processor, network connection, and computer readable medium, the computer readable medium encoding a software program configured to:
a. receive a first consumer preference data based on a user-interaction with a data source;
b. classify the data source based on a monitoring taxonomy, the monitoring taxonomy specifying a plurality of content categories and a plurality of relationships between the plurality of content categories;
c. aggregate the first consumer preference data and the data source classification with a plurality of consumer preference data and data source classifications;
d. rank the plurality of data source classifications based on the plurality of consumer preference data;
e. analyze a plurality of journaled internet data sources using the monitoring taxonomy to determine internet-medium consumer preference data;
f. rank the journaled internet data sources based on at least one of an interest level, a direction level, and an authority level; and
g. compute a content category ranking using the ranking of the plurality of data source classifications and the ranking of the journaled internet data sources.

12. The system of claim 11 further comprising a set-top-box configure to transmit the first consumer preference data to the server.

13. The system of claim 12, wherein the set-top-box is configured to transmit the consumer preference data at a configurable time interval.

14. The system of claim 12, wherein set-top-box is configured to transmit the consumer preference in response to a request from the server.

15. The system of claim 12, wherein the server software is further configured to remotely configure the set-top-box to monitor one or more particular user-interactions.

16. The system of claim 12, wherein the consumer preference data includes a viewing time.

17. The system of claim 12, wherein the consumer preference data includes a timestamp.

18. The system of claim 12, wherein the consumer preference data includes a direct user input for viewed content at any time.

19. The system of claim 11, wherein the server software is further configured to provide the content category ranking as an advertising data input.

20. A method of integrating consumer preference data and internet-blog consumer preference data for use in targeted advertising comprising:
a. receiving a user-interaction with a set-top-box interface to a data source;
b. transmitting data concerning the user-interaction and the data source to a server;
c. classifying the data source based on a monitoring taxonomy, the monitoring taxonomy specifying a plurality of content categories and a plurality of relationships between the plurality of content categories;
d. determining a first consumer preference data based on the data transmitted to the server and the data source classification;
e. aggregating the first consumer preference data and the data source classification with a plurality of consumer preference data and data source classifications;
f. ranking the plurality of data source classifications based on the plurality of consumer preference data;
g. analyzing a plurality of blogs using the monitoring taxonomy to determine an internet-blog consumer preference data;
h. ranking the plurality of blogs based on at least one of an interest level, a direction level, and an authority level;
i. computing a content category ranking using the ranking of the plurality of data source classifications and the ranking of the plurality of blogs; and
j. providing the content category ranking as an advertising data input.
